(19) United States
(12) Patent Application Publication
(10) Pub. No.: US 2007/0276691 A1
(43) Pub. Date: Nov. 29, 2007

(54) System and method for processing orders from a menu

(75) Inventor: Richard Grant, Davie, FL (US)

Correspondence Address: Roger S. Thompson, Esq.;Cohen Pontani Lieberman & Pavane LLP, Suite 1210, 551 Fifth Avenue, New York, NY, 10176, US

(73) Assignee: OrderCatcher, LLC

(21) Appl. No.: 11/803,492

(22) Filed: May 14, 2007

Related U.S. Application Data
(60) Provisional application No. 60/800,060, filed on May 12, 2006.

(51) Int. Cl. G06Q 10/00; G06Q 30/00

(52) U.S. Cl. 705/1

(57) ABSTRACT

Methods for presenting options on a telephone based, tree-structured, ordering system. The methods include re-sequencing the menus based upon the individual user's ordering history. When a menu is re-sequenced, the new order of the menu is structured so that the individual menu items are presented to the user in the order deemed to reflect the likelihood that the user will most likely order the first item on the menu. The second-most-likely-to-be-ordered item is presented second, and so on. Additionally, the user may navigate through the menu either by following the menu, or by choosing items from anywhere on the menu, even if the option selected is not one currently being presented to the user. The user may also navigate through the menu tree in a non-linear fashion, such as by repeating or skipping menu items.

### CROSS REFERENCE TO RELATED APPLICATIONS

This application claims priority from, and is a continuation-in-part of, U.S. Provisional Patent Application Ser. No. 60/800,060 which was filed on May 12, 2006.

### BACKGROUND OF THE INVENTION

1. Field of the Invention

The present invention is directed to systems and methods for taking orders for items, and, more particularly, to a system and a method for taking orders from customers via telephonic voice communication through a dynamic menu system.

2. Description of the Related Art

The economy is based on a simple foundation. A business has a supply of goods and/or services that it offers to provide to consumers. If there is a demand for the goods/services, and the price at which the goods/services are offered is attractive, a consumer may decide to purchase the goods/services from the business. If not, the consumer may look elsewhere to satisfy his or her needs. In a competitive environment, businesses must compete not only on price, but on quality of the goods/services provided as well as on more subjective bases, such as the quality of the experience a consumer has in dealing with a business.

In today's economy, there is a premium placed on the efficient and rapid processing of orders of all kinds, from fulfilling takeout orders from fast-food restaurants to fulfilling inventory orders from manufacturers. In any environment, a business' success depends upon its ability to process orders quickly, accurately and with high consumer satisfaction, which depends in large part on the accuracy and speed of the ordering process. Customers who aren't happy don't come back, and businesses want customers to come back.

Business profitability also makes these same factors important, since, in a competitive environment, a business must not only keep its customers happy but also keep its costs down. One key ingredient in the cost analysis is the cost of running a telephone order operation, or “call center”. Businesses that run 24/7 can spend thousands, tens of thousands, or even millions of dollars, depending upon their size and field, in setting up and maintaining order-taking call centers, and there is still no guarantee that orders will be taken accurately and quickly enough to satisfy customers.

Technology has increased businesses' ability to take orders from customers, but has also increased consumers' expectations for the processing of ordering transactions. Where once consumers were content to receive a Sears catalogue by mail once a year, and place an order by mail to receive their desired goods two months (or longer) thereafter, consumers now expect immediate satisfaction. Consumers expect, and demand, that businesses provide the requested goods/services almost by the time the phone is hung up, or the mouse click is over. One technology that has quickened the consumer's desire for immediate satisfaction is the telephone. A consumer wants to be able to pick up the phone and have what he wants delivered, with a minimum of fuss and bother. In some ways, the immediate satisfaction offered by placing orders over the Internet has given impetus to consumers' shortened patience; and led to demands for ever quicker response and service. Not all ordering systems and market forces are compatible with the Internet, although that does not mean that consumers' desires for immediate satisfaction are lessened. Telephone-based ordering systems are one paradigm of an ordering system that has not heretofore provided a satisfactory experience, but where consumers' increased expectations have led to some degree of dissatisfaction with what was once a perfectly acceptable way of doing business. This is especially true for automated telephone-based ordering systems. Many consumers feel that they are slower, less efficient, less personal and therefore less satisfactory to meet their expectations; yet businesses prefer their lower cost. There is therefore an ever-increasing tension between a customer's desire for speed, accuracy and personalized service and a business' desire for lower cost, quicker ordering and improved customer satisfaction.

Various telephone-based ordering systems have evolved in an effort to speed the time of communication between a business and its customers. One of the original systems is the “Push 1 for . . . ” system. In such systems, a voice prompt asks the user for a specific response and asks that the response be input by way of the telephone keypad by Dual Tone Pulse Frequency (DTMF) input. Such systems are limited in their input, and require that users wait until their preferred option is presented before receiving input. These systems are cumbersome and do not provide the best customer experience by virtue of their rigidity and lack of responsiveness. They are one of the prime reasons consumers have grown suspicious of “voice mail hell” systems.

The next generation of telephone ordering systems allowed for voice input as “Press or Say 1 for . . . ” In these systems, the user is allowed to input his response by voice, which made the process easier, in that pushing was no longer required, but otherwise suffered from the drawbacks of the earlier systems.

A breakthrough of sorts in voice menu technology came with “Barge-In” technology, in which a user who was aware of his options could press or say the desired response even before it was offered. While this would speed up the system for those familiar with it, it did not necessarily help those who were unfamiliar with the system, and did not offer the ability for a user who was truly familiar with the system to move through the system other than by way of a highly structured tree system. While a repeat user of a bank's voice mail system, for example, may learn that saying “1” at the first prompt leads to a desired checking account sub-menu, while saying “3” at the checking sub-menu allows for searching for transactions, and then saying “4” permits searching for a specific check number, it is still a lengthy, and oftentimes frustrating, process to wait to say, “1”, pause, “3”, pause, “4”, pause, and then identify the check number. It is also not helpful to new users who do not know which options are available and in what order, so that they must wait for their desired option to be presented.

These systems also suffer from the severe drawback that they are completely linear in the order in which options are presented to the user, with the option “1” always being presented before “2”, even if the user has never chosen option “1,” and never will.

Known systems suffer from the further drawback in that businesses are constantly changing their voice menus to suit their business needs (Most users are familiar with the message: “Please listen to our menu options because they have recently changed”.), and these new menus force users to re-learn their familiar patterns and lose efficiency in navigation through the static menus. They also do not permit the repeating of individual menu items without re-starting the entire menu, or skipping ahead past some options that may not be of interest to get to other options that may be of greater interest.

The next evolution of telephone ordering system provided that a user could say “Press or say ‘1’or ‘Sales’ . . . ”, i.e., the user had the option of pressing or saying the number corresponding to the known option, or identifying the option by way of a short verbal identifier, e.g., “Sales”. This gave an additional layer of flexibility to the user since not only did he now have to wait for the system to offer a particular option, the user could attempt to intuit the likely identifier of the option he wanted, and avoid having to listen to the list of prompts even if he was completely unfamiliar with the system.

The prior known systems, however, still suffered from a number of drawbacks.

A prime drawback is that the menus were static, and could not be tailored to the history of a specific user's ordering pattern. For example, a user who always ordered the same thing located on the fourth sub-menu from the main menu would have to go through the tedious process of stepping through the levels of menus to reach the desired item to be ordered.

Known systems also suffer from a common limitation in voice-based systems, viz., the size of the corpus of the database of the voice engine which is available to recognize voice inputs. Most voice-responsive telephone-based systems do not create their own database of words that they expect to hear from the user. In other words, while “Say ‘Sales’ for Sales . . . ” may work with the common English word “Sales”, it works less well where the menu selection is “Pasta Fagioli” (commonly pronounced “Pasta Fazool”), or particular technical terms that may not appear in a corpus of English words. These systems generally are not designed to accommodate words that are not found in the common English language corpus.

Perhaps the greatest drawback to such systems, however, is that they are essentially linear, or at least tree-like in nature. For example, a user would have to go through a series of menus, each with its own set of options before finding the selection he or she may want. Once a menu started, known systems do not permit the user to go back to hear a prior option, without re-cycling the entire list of options then available, or permit the user to skip all or part of the list to hear potentially preferred options that may lie further down the branch of the menu tree.

Many ordering systems exist for placing orders over the Internet, such as U.S. Pat. Nos. 6,249,773 and 7,050,977. However, not everyone has access to the Internet, or at least not convenient access to the Internet at all times (while driving, or at locations where the user may not be able to use a laptop conveniently). In these circumstances placing an order by telephone (for example for Chinese food to be delivered when a driver reaches home) may be a much more convenient option, or even the only option.

Internet ordering is very different from ordering by phone, and so schemes for placing orders over the Internet do not lend themselves well to incorporation in a telephone-based system. For example, on a web page, a user may search for a name, look over multiple menu options at a glance, and access any portion of the web page with a simple mouse click. Telephone-based systems, do not have that luxury, since there is no visual presentation of options (while some phone may function as a web browser, they access web-based systems in their capacity as a gateway to the Internet, and not as a true telephone communication). They are, by their vary nature, limited to static, linear presentations of options.

Other systems, such as disclosed in U.S. Pat. No. 6,941,273 and Published United States Patent Applications Nos. 2001/0047264 and 2002/0010646 utilize the voice interface of telephones to provide an enhanced consumer experience with ordering systems. They do not, however address the problems of dealing with linear menu trees, or providing for random access to items located on a linear menu tree, where those items may be located on a branch or sub-branch of the menu tree that is different than the branch or sub-branch on which the user is presently located.

The prior art also does not address the problem inherent in a static linear menu tree system that a user must follow the logic of the tree to reach a destination. Known menu trees do not adapt to the needs of a specific user, for example by adapting the order of a menu to reflect the prior history of that specific user.

There is thus a need in the art for a telephone-based menu-tree ordering system which addresses these shortcomings, and provides users thereof with an improved experience in ordering from the menus available.

### SUMMARY OF THE INVENTION

It is therefore an object of the invention to provide a system and a method which overcome the drawbacks of the prior art.

It is another object of the invention to provide a telephone-based ordering system with additional navigation capabilities, to enhance the user's experience in dealing with the system, and thereby encourage ordering from the system, and returning to the system for later orders.

It is a still further object of the invention to provide a system and a method for ordering items in which a user may more easily and accurately place an order.

It is a still further object of the invention to provide a system and a method for ordering items in which the user's history of ordering items from the same source shapes the way options are presented to the user, so that a user who repeatedly orders certain items from the same source is presented with a simple way to re-order the items he or she has previously ordered.

It is yet another object of the invention to provide a telephone-based menu system that would permit a user more options in navigating the menu, such as by providing the ability to move non-linearly from one branch of the menu to another, or to repeat menu items, or move up or down a list of menu items to permit the easy selection of items from the menu.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is logical diagram showing the operation of a static, linear menu tree as known in the prior art.

FIG. 2 is a block diagram showing the inventive system for practicing the inventive method.

FIGS. 3-5 are flow charts showing the practice of various modules of the inventive method.

### DETAILED DESCRIPTION OF THE PRESENTLY PREFERRED EMBODIMENTS

The inventive system and method are intended for use in the context of receiving orders over a telephone line, and fulfilling those orders quickly and accurately. While the invention has broader utility, for concreteness of description it shall be described in the context of taking orders for Chinese food from a restaurant that provides take-out food, as well as, perhaps, offering a traditional seated dining experience.

In this context, the inventive system is referred to as a “telephone-based” ordering system which, in this application, is intended to mean that it answers a telephone call, either through a POTS system, through VoIP, or any other mechanism, to receive an order of some kind. The interface is intended to be through voice, or the keypad of a phone, and is not intended to include a system which is based upon a web browser or other Internet-specific application, in which the user may have access to a computer GUI or other computer-like interface. It is strictly intended for use with a voice menu tree (as that term will be defined) in which menu options are presented as an ordered sequential list of choices, with some of the choices leading to other lists, and so on.

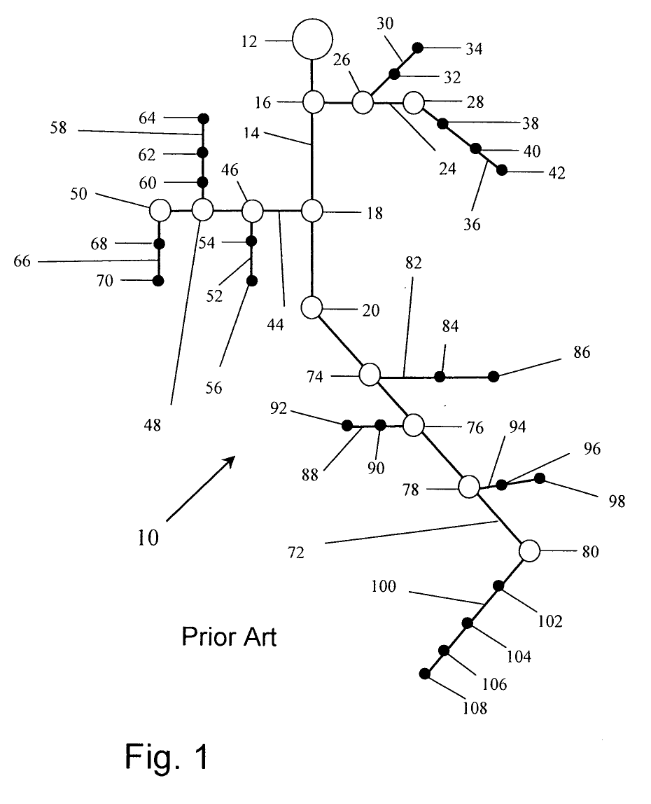

A voice menu tree as found in the prior art is shown in FIG. 1, generally at 10. In voice menu tree 10, the user enters the tree through an entry portal, or gateway, 12. Portal 12 offers the user a list 14 of initial options, such as “Lunch” 16, “Specials” 18 and “Dinner” 20. Each option has its own portion of the menu associated therewith. Each list of options is referred to as a “branch”, and a list which is a sub-list of a list higher on the tree is a “sub-branch”.

It will be appreciated by those of ordinary skill in the art that the precise ordering of the voice menu items, as well as the number of options, is purely dependent upon the application and is a mere matter of design choice. For ease of illustration only, and not for limitation, the voice menu is shown with a relatively limited number of options, branches, etc. Some applications could easily call for hundreds of options, with many sub-menus, sub-sub-menus, etc., with the only limitation being the designer's imagination and/or the needs of the application.

Continuing the description of menu tree 10 in the context of a Chinese menu, Lunch option 16 could have its own branch 24 of options, such as Combination Plates 26 and Entrees 28. Combination Plate sub-branch 30 may offer the choices of Combination A 32 or B 34. Entree option 28 may lead to an Entree sub-branch 36, offering Sweet and Sour Chicken 38, Spicy Shrimp 40 and Roast Pork with Almonds 42.

In the context of the invention, any menu choice that offers a further list of choices is sometimes called a “node” such as option 16, 18 or 20, while actual menu selections such as Combination A 32 or Roast Pork with Almonds 42 which does not lead to a further list is referred to as a “leaf” of the menu tree.

Returning to the description of menu tree 10, Specials option 18 from list 14 may include a further list (sub-branch) 44 such as Appetizer Specials 46, Seafood Specials 48 and Chicken Specials 50. Appetizer Specials may have a list 52 of BBQ Ribs 54 and Won Ton Soup 56. Seafood specials may include a list 58 of such items, such as Honey Prawns 60, Szechuan Shrimp 62 and Shrimp Lo Mein 64. Chicken Specials 50 may include its own list 66 such as General Tso's Chicken 68 and Moo Shu Chicken 70.

Dinner option 20 would lead to a list 72 of available dinner items, such as Dinner Appetizers 74, Seafood Dinner Entrees 76, Pork Dinner Entrees 78 and Chicken Dinner Entrees 80. Dinner Appetizers 74 would include a list 82 that includes Egg Roll 84 and Hot and Sour Soup 86. Seafood Dinner Entrees 76 would include a list 88 that may include Shrimp in Black Bean Sauce 90 and Scallops with Garlic Sauce 92. Pork Dinner Entrees 78 would include a list 94 that includes Pork Egg Foo Young 96 and Pork Hunan Style 98. Chicken Dinner Entrees 80 would include a list 100 that includes Chicken with Broccoli 102, Moo Goo Gai Pan 104, Sesame Chicken 106 and Chicken with Black Bean Sauce 108.

It will again be stressed that this menu tree is limited for presentation purposes only, and that an actual menu tree for a Chinese restaurant would have many more branches, sub-branches, nodes, leaves, etc. For example, it would be likely that, in practice, the menu would have sub-menus for beverages, desserts, etc. It will also be stressed that conventional menu trees are, as illustrated and discussed thus far, “linear”, meaning that they are structured so that each menu item is found sequentially on a list that may be selected at a node “higher” on the tree, and that different options are offered to a user in a pre-defined and fixed sequence.

In prior art menu trees, the user would be given the sequential list of options available at each node, in a predefined order. The user would have no option to move within a list, except to go out of the current list to the node higher up (as in “Press 9 to return to the previous menu”) or to the original menu (as in “say Main Menu” to return to the Main Menu). The user of such a prior art menu tree is not permitted to choose a selection without stepping through the menu tree, and must step up a level (or two) to go down to a choice (leaf) that may be of interest on another branch or sub-branch. For example, if the user wants to order Sesame Chicken 106 and Szechuan Shrimp 62, he would have to follow the following path:

1) Go through portal 12;

2) Listen to list 14 (Main Menu);

3) Choose Specials Option 18;

4) Listen to list 58 until Szechuan Shrimp 62 was mentioned;

5) Select Szechuan Shrimp 62;

6) If the system supported it, return to the Main Menu directly, otherwise, he would have to step through the prior menu options one at a time to return to Main Menu 14;

7) Re-listen to Main Menu list 14;

8) Select Dinner Options 20, and listen to list 72 until Chicken Option 80 was selected;

9) Listen to Chicken Entrees list 100 until Sesame Chicken 106 was offered;

10) Select Sesame Chicken; and

11) Checkout.

In more advanced systems, the user may be able to make numerical selections corresponding to the options available prior to hearing the entire list, presuming the user had committed to memory all possible menu options on the Chinese takeout menu, and did not make a mistake, and also presuming that the restaurant had not re-sequenced the list for any reason. This is, clearly, a time-consuming process, fraught with the opportunities to make mistakes and to get lost in the menu tree if the precise combination of choices was not made, in the right order, with the proper pauses between them so that the system could recognize the entered sequence correctly.

In accordance with the invention, however, this presentation and process is quite different, as will be discussed in greater detail below.

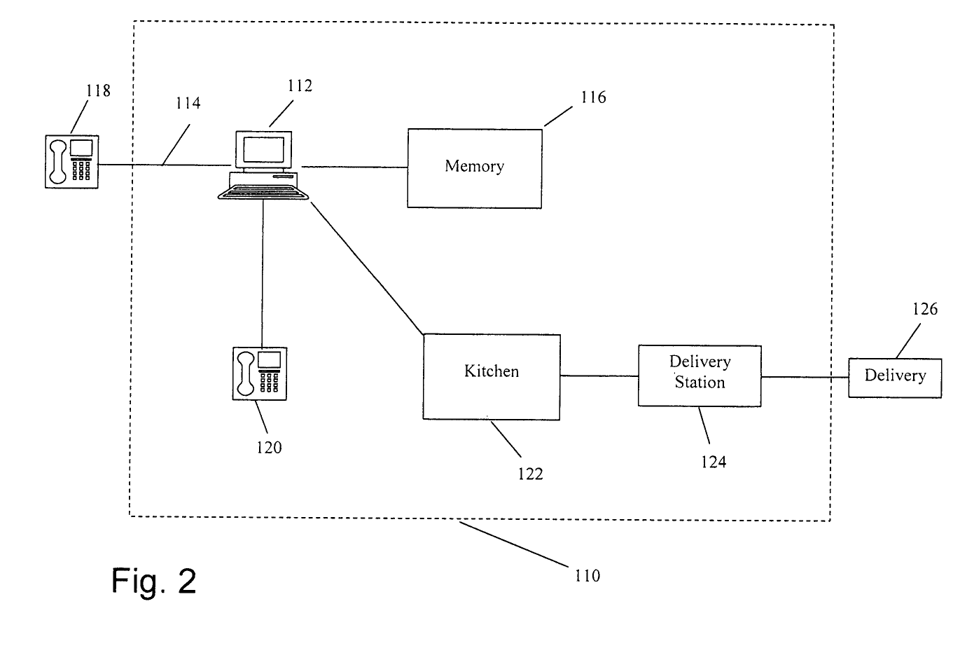

A system for practicing the invention is shown in FIG. 2, generally at 110. The inventive system 110 includes a computer 112, capable of receiving at least one telephone line 114. In the preferred embodiment, computer 112 has either four or eight lines. However, for ease of illustration, only one line is illustrated. Computer 112 has access to a memory 116, which may be internal to computer 112, or accessible to computer 112 through a network, or otherwise, such as over the Internet. Memory 116 includes voice recognition software, with a predefined vocabulary or corpus of words in its database In the preferred embodiment, Microsoft Speech Server is used. In some preferred embodiments, the predefined vocabulary may be in more then one language, e.g., English and Spanish, but for simplicity of discussion, it will be discussed in general terms as having a vocabulary in a single language, English.

Computer 112 is configured to receive a voice communication from a telephone outside of system 110, such as a telephone 118. Telephone 118 is illustrated as a standard telephone, although it could be a wireless telephone, a cellular telephone or even another computer operating under the Voice over Internet Protocol (“VoIP”). The manner of communications is immaterial, what matters, for purposes of this invention, is that a voice communication is received by computer 112.

System 110 also preferably includes a telephone 120 connected to computer 112, to receive any calls that need to be directed to an operator, such as where a caller who calls into the system simply prefers to deal with a human being rather than an automatic ordering taking system, or where the system has been unable to understand the caller's voice responses.

In addition to the vocabulary, memory 116 further includes the menus available to system 110, such as a lunch menu or a dinner menu. Many restaurants offer different selections for the two menus, and so they may be offered separately, or at specific times although this is not required. In many Chinese restaurants, for example, the lunch menu may offer “combination” meals only available at specified times of the day, such as Combination A 32 and Combination B 34 (FIG. 1). Other options would include special holiday menus, catering menus or any other specialized menu that may be offered by the establishment.

The inventive method is shown, generally at 210 in FIG. 1. For this discussion, it will be presumed that the ordering system is intended to provide for ordering Chinese food, although it will be appreciated by those of ordinary skill in the art that other types of goods and/or services may be ordered through this system.

According to method 210, a consumer phones in to place an order (212) and thereby enters menu tree 10 (FIG. 1) at portal 12. The answering system picks up the phone (214) and retrieves the Caller ID information from the local telephone system, if available (216). If no Caller ID is retrieved, the system asks for the caller's telephone number, and this is later confirmed, or the telephone call is routed to an operator for identification (218) as a matter of design choice. In this case, the operator asks for the telephone number from which the call is made, secures the order in traditional fashion, and determines if the order will be picked up or delivered, and, if delivered, to what address. This information is then stored in memory 116 (FIG. 2) either immediately by the operator, or later by another person.

If the Caller ID recognizes the phone number as a telephone number, then the system reads an introduction (220), in which the caller is welcomed to the system, and provided a description of the operation of the system. The introduction informs the caller of the identity of the provider he has reached, and a list of operations that may be performed. These operations include:

“Help” to get help;

“Repeat” to repeat the current prompt;

“Instructions” to get full instructions; and

“Operator” to be transferred to an operator.

These words are known as “Always Listening” words, for which the system listens at all times, without further prompting. If the system recognizes an Always Listening Word, it reacts accordingly. Specifically, if the user says “Help”, then system 110 reads a context-sensitive Help Menu. If the user says “Repeat” the system repeats the previous menu option. If the user says “Instructions”, the message reciting the instructions is repeated. If the user says “Operator” the call is immediately switched to a human operator for further processing of the order. In some applications, human operators may not be available 24/7, and so, under these circumstances, the user is advised that no human operator is available at that time, and the user is given the option of hanging up to try again later or proceeding with the automatic order taking system.

In some applications, the specific “Always Listening” words available at any given location in the menu tree may be context-sensitive so that different words, having different functions, may be recognized, depending upon where in the menu the user is then located. The precise word(s), their function(s) that may be suitable are purely a matter of design choice.

After reading the introduction, the system looks (222) in memory 116 to determine if the calling telephone number is one with a history in the system. If the number has no history, the caller is a new caller, and the call goes through an initial caller procedure (224). If the caller has called before, the caller is given a different menu selection, a repeat caller procedure (226).

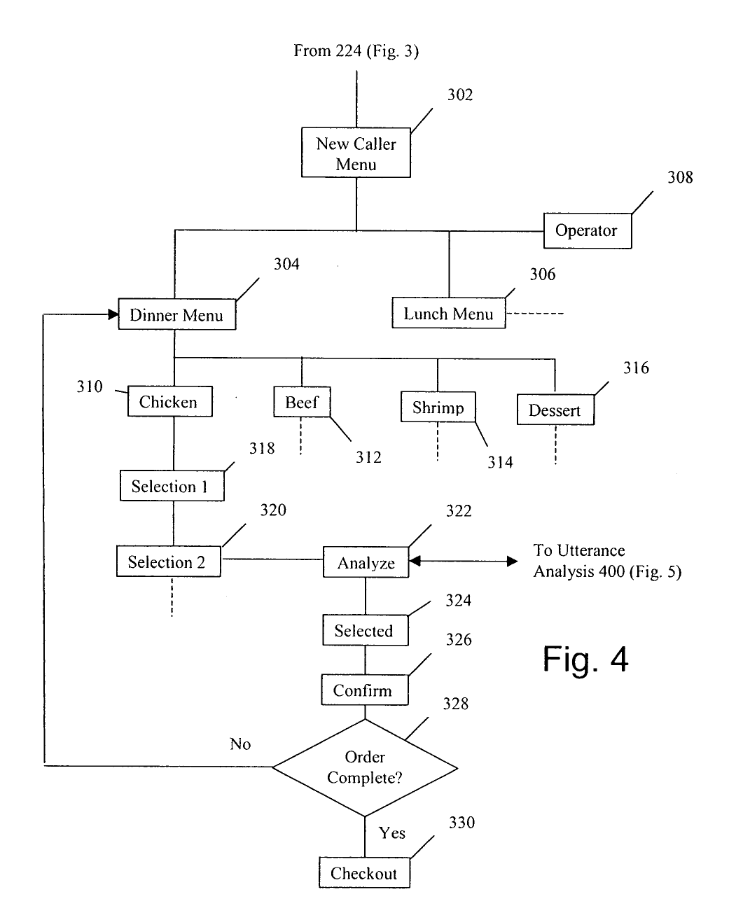

The initial caller procedure (224) is shown in FIG. 4. In this procedure, the caller is sent to a new caller menu (302) that provides the new caller with a limited set of options. The new caller may select either a dinner menu (304), a lunch menu (306), say one of the Always Listening words or go to the operator (308). In a preferred embodiment of the invention, these options may be activated by a voice command, such as: “Main Menu”, “Lunch Menu”, one of the Always Listening words, and “Operator” respectively.

In the preferred embodiment, memory 116 (FIG. 1) has a large vocabulary, which includes all of the available words that may be needed for system 110. However, searching through a large vocabulary of possible words takes a lot of time and computing power to handle, and most restaurants are extremely cost-sensitive to technology, since their primary product is food, not computers. For this reason, it is preferred that the list of available vocabulary choices to the voice recognition software be limited whenever possible to speed up the search, and thereby minimize the number of false positives to the extent possible.

Thus, when the first list of options is presented to the new caller, it is preferred that it be limited to the three options described.

If the new caller says “Operator”, he is referred to an operator (308) in the same fashion as in step 218 (FIG. 2). If he selects one of the other two options, he receives the list of options designated for that option. For purposes of illustration, it will be presumed that the caller selects the dinner menu (304), and receive a list of available options, such as: Chicken (310), Beef (312), Shrimp (314) and Dessert (316). Each restaurant may design an appropriate list of options, matched to its menu and clientele. Each of the options will then have a sub-menu of available items appropriate for the choice and the restaurant. When the system is initially set up, the ordering of the items on the menus is chosen by the restaurant to conform to the order that the restaurant expects to be the most popular with its customers. This is subsequently changed, as will be discussed presently.

For purposes of this discussion, it will be presumed that the restaurant offers four sub-menus: Chicken (310), Beef (312), Shrimp (314) and Dessert (316), although, in practice, most restaurants would offer many more selections, and the number and titling of such menus would be a mere matter of design choice for one of ordinary skill in the art.

At this point, computer 112 advises the new caller that the list of classes of items available to him for selection is: “Chicken”, “Beef”, “Shrimp” and “Dessert”. The user is advised that the proper procedure is to say the name of the class or to say “Select” when a desired option is mentioned.

After the user selects the class, he is presented with a voice prompt reciting a sub-class menu of the class items. This is the listing of actual menu items. Some of the menu items may, however, have further sub-sub-classes, depending upon the desired menu structure. The user is instructed on how to navigate the sub-class, and has the following options:

“Select” to choose the menu item being offered;

“Review” to review the current order;

“Next” to move to the next item on the current menu;

“Previous” to return to the previous item on the current menu;

“Main Menu” to return to the Main Menu;

“First” to go to the first item in the current menu; and

“Last” to go to the last item in the current menu.

In addition, in a preferred embodiment of the invention, the system is set up to recognize the common English words used in the menu, such as “chicken”, “beef” and so on. The corpus of the voice database will have most of the required English words, but not likely specialized Chicken food words, such as “Szechuan”, “Hunan”, etc.

The user then navigates through the menus 310, 312, 314 and 316 by using these commands to select the items desired. Once an item is selected (322), the caller is asked to confirm the choice (324), is advised the price of the item, and then asked to advise how many of these items he wishes. The user is then asked if the order is complete (326). If the user wishes more items, he says “No” and is re-directed to the menu selections at step 304, to select the next choice from the list of class items, and repeats the procedure until the order is complete.

Once the user has completed his ordering from a specific sub-class menu, he may move to another class menu by saying the name of that menu (e.g., “Beef”) to choose from that menu, as well as by stepping upwards through the menu tree as in the prior art. This process continues until the order is complete. The user then is given the opportunity to check out (328).

To check out (330), the system recites the complete order, and the total over the telephone to the user. The user is then asked if the order is correct. If the user accepts the order, he is asked if it should be a pick up or a delivery. The computer looks at the listing of orders now in the queue, and determines how long it will take to prepare the order. If the user wants delivery, then the user must record his name and address, and this information is recorded to an audio file that is linked to the order if not already in the system. The caller's telephone number and order history are stored in memory 116, so that the order history is associated with the telephone number.

The system then advises the caller how long it is estimated to be before the order is delivered.

The call is then terminated, and a timer starts to count how long the order has been in the system. The person at the register may look at the order to determine if the order appears obviously erroneous (e.g., 350 egg rolls) and listens to the audio file to determine if the order appears legitimate (e.g., not an obvious prank call). If the order passes this initial inspection, the person at the register moves the order to processing (kitchen 122, FIG. 2).

If there is any suspicion aroused, there can be a callback to confirm the order and its legitimacy. In addition, the software may preferably interface with map checking software to ascertain the veracity of the address provided.

If the order is passed to kitchen 122 (FIG. 2), kitchen 122 then begins to prepare the order, and a second clock starts to count how long the order has been in the kitchen. Once the order is complete, it is given to a delivery station 124, where a third clock begins to run. As soon as the order is ready, it can be sent out for delivery 126 by any suitable method (runner, bicycle, car, etc.), after being checked for accuracy at delivery station 124.

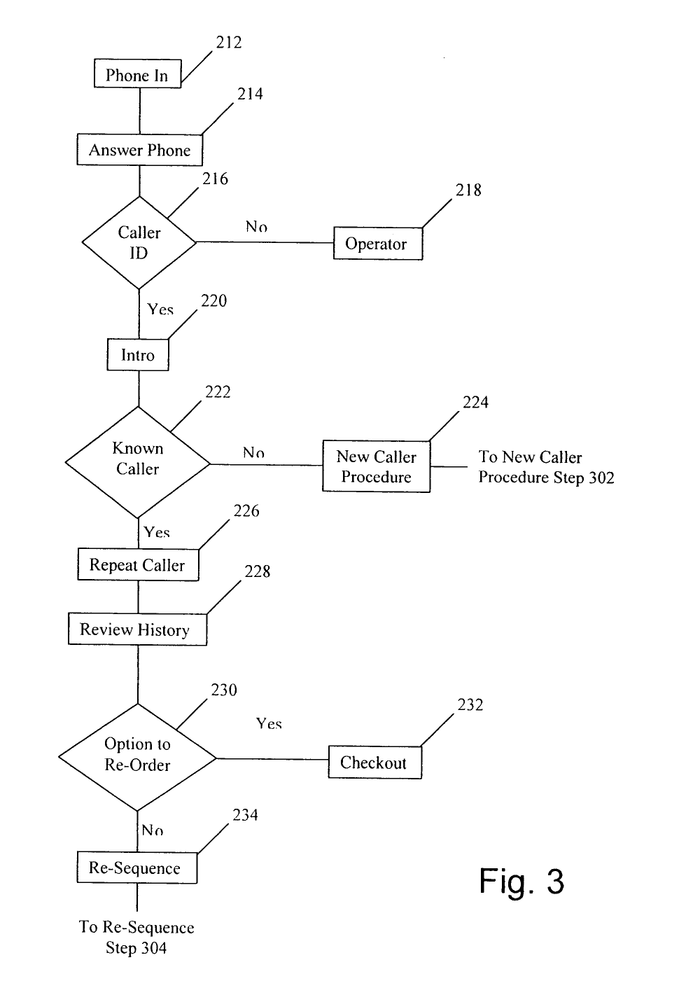

If the computer recognizes the caller as a prior caller (step 226, FIG. 3), then the options provided to the caller are different. In addition to the options offered to a new customer of ordering any item from the complete menu, the repeat customer also is offered the ability to re-order items he has ordered before. To do so, the computer recognizes the prior caller, and checks the caller's ordering history to re-sequence the menu options and thereby customize the menus presented to the customer to make the ordering process quick and easy.

When a repeat caller is identified (226, FIG. 2), computer 112 reviews the stored history of orders from the caller (228), which have been stored in memory 116. The caller may be first given a direct option to simply re-order the last order placed (230). If the User says “Yes”, she is directed to checkout (232). If not, the items previously ordered by that caller are given a priority in their placement on the menus of options offered to that caller (234). For example, if the caller has previously ordered Chicken with Broccoli, that item will become the first item on the Chicken list for that caller, and the Chicken menu will be listed as the first choice of menus (as shown in FIG. 4). If the caller does not order Chicken with Broccoli on her subsequent call, but orders instead Chicken with Mushrooms, that item becomes the first item on the this call, and Chicken with Broccoli becomes the second item, and so on, so that the items which are never ordered by the caller gradually fall to the bottom of the menu, while those items asked for most often stay at the top of the list. As a matter of design choice, over time, the listing of items may be weighted depending upon the frequency with which each item is ordered, and the recency of the date in which the item was ordered, so that items which once were ordered frequently, but which have not been ordered for some time may be dropped in primacy in the sequence of the re-sequenced list. One of ordinary skill in the art will readily appreciate that the way the weighting is performed is a mere matter of design choice.

The ordering system works best with the customers who order the most often, in other words the most valued customers. Such customers are rewarded with the most precise customization and best service.

As stated, the inventive method may be used to order any type of goods and/or services. For example, it may be used for other types of food ordering, e.g., pizza. It may also be used in a “hard goods” ordering system, such as for the ordering of replacement ink cartridges for computer printers or replacement filters for air humidifiers. It is of particular utility in system in which there may be a large number of possible choices, but a user is likely to order certain specific items over and over, so that the history of the orderer is of some value.

Reduced to the ultimate in service, for example, a regular customer who calls in several times for the exact same order will be recognized by his Caller ID, and the ordering process will go something like this:

### [Ring]

[Pick up call] “Hello Bill, thanks for calling. Would you like you usual, [list the usual order]”

### “Yes”

### “Would you like that delivered to your home at [state address]?”

### “Yes”

“Thank you for calling. We appreciate your business. The order should be at your house in ______ minutes.”

### [Hang up]

This entire order could take place in less than 20 seconds, with the customer only being required to say the word “Yes” twice. The system can be used most effectively where repeat customers order the same items repeatedly, such as preferred Chinese food items, preferred pizza orders, or replacement parts that wear out constantly, such as laser printer toner cartridges or humidifier filters. The system, however, may also be used to improve ordering for any kind of orders where offering the customer the ability to have his options specifically targeted to his historical ordering preferences, without the consumer having to answer questions, or think about what he might prefer. The system customizes the process to make re-ordering simple and efficient.

In a preferred embodiment of the invention, inventive system 110 will also allow navigation through the menu tree of options by direct access to an option on the leaf of the menu tree by directly asking for the option, rather than having to work through an ordered list. This works especially well where the list is of generally known options (such as a takeout menu) and the words which identify the individual items are words in the corpus of the English (or other language) database of words available to the voice recognition software.

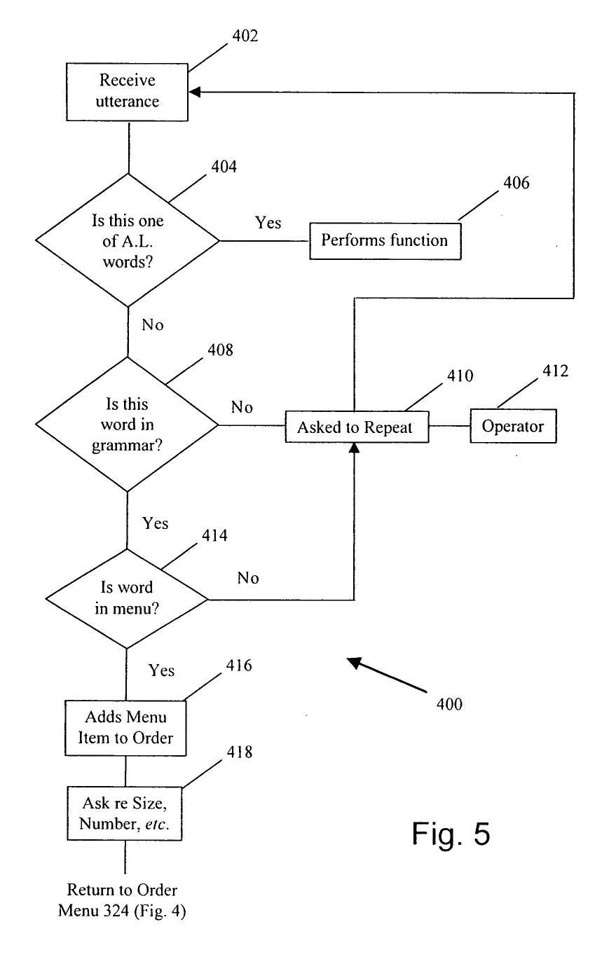

These steps of the preferred embodiment are shown in FIG. 5, generally at 400. First, system 112 receives an utterance (402) from the user (see, step 322, FIG. 4). System 112 then analyzes the received utterance and uses the voice recognition software to determine if the utterance contains an Always Listening word (404). If it does, then system 112 performs the function associated with that word (406). If the utterance is not an Always Listening word, then system 112 compares the received utterance with the words in the voice recognition corpus. If the word is not recognized (408), the user is asked to repeat the word (410), in case there was a pronunciation error, or an unclear transmission of the utterance over the telephone line, or any other error. The system returns to step 402 and the new utterance is analyzed for whether it is an Always Listening word (404), if not, the new utterance is analyzed to determine if it is in the grammar (408) if not the user will be sent to the operator (412) for a termination of the automatic processing of the order.

Since the goal of the system is to secure an order as efficiently as possible, with the highest possible customer satisfaction, it is important not to permit a user to become frustrated with the automated processing of the order simply to make the process “faster” or cheaper. Having a fast process which does not result in an order is of no use. Depending upon the application, it may be possible to allow for more than one “loop” through the voice recognition. For example, if it is determined that the customer base generally has a high threshold for frustration, the user could be given the option of continuing (as, for example, if there is no operator on duty at the particular time of the call) or of leaving a message with a request for a callback to secure the order. All of these options are a matter of design choice that one of ordinary skill in the art would appreciate could be implemented without undue experimentation. It will also be appreciated by one of ordinary skill in the art that the user could be sent automatically to the operator if the total number of repeated words in an entire order reaches a threshold, again, so as to avoid the possibility of user frustration and increase the likelihood of securing the order.

If the comparison performed in step 408 finds that the utterance is actually a recognized word in the list of possible words (“grammar”), then the voice recognition software outputs the text associated with that recognized word. If that text represents a menu option (414) then system 110 adds the appropriate menu option to the order (416). If it is not, the user is returned to the “please repeat” step (410).

Once the menu item has been understood, the user is interrogated for any options that may exist, such as: “How many of the item do you want?”; “What size do you want?”, “Would you like that ‘Spicy” or ‘Regular’”, as may be appropriate for a particular menu item. The relevant information is then processed and placed in the checkout list.

Once the processing of an utterance is completed, the user is returned to the order processing menu (FIG. 4) where she is asked to confirm that the last section was correct (326) and asked if the order is complete (328). If it is complete, the user is sent to check out (330) where the complete order is confirmed, delivery or pickup options are confirmed, method of payment is confirmed, etc., in any desired fashion.

If the order is not complete, the user is permitted to continue the ordering process, either by returning to the menu selection list (step 304), or through direct ordering through the processing of a direct utterance (400, FIG. 5).

As stated above, it will be appreciated by those of ordinary skill in the art that not all menu options may be found in a standard database of voice recognition software. Some foreign words may have English analogues, for example the Chinese dish “Dim Sum” may be recognized as a combination of the common English words “dim” and “sum”, even though the meaning of those English words would not have relevance in the context of the Chinese food takeout menu. In such an instance, it may be possible to use English analogues of foreign words to generate an order. In the alternative, it may be preferred to avoid the possibility of confusion, mispronunciation or other error by limiting the use of English analogues. Either way, one of ordinary skill in the art could make informed choices for the permissible inputs based on the particular application, including any regional variances in pronunciation of any specific menu item compared to the “norms” of expected pronunciation of words in the grammar being used in the application.

In some applications, it may be possible to add a specific word to the grammar of available words from the database, in accordance with the parameters of use of the grammar. This presents certain drawbacks, however, since the added word will not have the usual expected accuracy of the standard grammar. Additionally, depending upon the application, the business who purchases the inventive system may not have the capability of adding such information in-house (as in the case of a small Chinese takeout establishment) or be willing to undertake the expense of paying an outside contractor to do so.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Additionally, also by way of example, the identification associated with the user could be a code other than a telephone number, for example a “user ID” or other identification. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for personalizing a telephonic menu-based ordering system as a function of an identification of a user, the method comprising:
a) determining if the user has used the system previously;
if the user is a new user:
b) establishing an initial personal history from the user;
c) wherein said initial personal history includes an identifier;
d) offering the user an initial menu of options in a first predefined sequence;
e) permitting the user to make a first selection from said initial menu;
f) correlating said first selection from said initial menu with said identifier;
g) storing said first selection from said initial menu in connection with said identifier;
h) generating a first re-sequenced menu as a function of said first selection;
if the user is not a new user, and therefore has said first re-sequenced menu associated with said identifier:
i) offering the user said first re-sequenced menu;
j) permitting the user to make a second selection from said first re-sequenced menu;
k) correlating said second selection from said first re-sequenced menu with said identifier; and
l) storing said second selection from said first re-sequenced menu in connection with said identifier.

2. The method of claim 1, further comprising the step of:
m) generating a second re-sequenced menu as a function of said second selection.

3. The method of claim 1, wherein said identifier is a telephone number, and step a) is performed by comparing the telephone number of the user accessing the telephone menu-based system with the telephone numbers from which prior users have accessed the system.

4. The method of claim 1, wherein said function is to place the most-recently made selection at a position in said re-sequenced menu in which said most-recently made selection is offered to the user earlier than in a prior offered menu.

5. The method of claim 1, wherein said function is to place the menu selection most often made by the user as the first offered selection in the re-sequenced menu.

6. The method of claim 1, further comprising the steps of:
n) after a specific user has accessed the telephone menu-based system a pre-determined number of times, establishing a regular order from the user; and
o) offering the user a menu in which at least one item from said regular order is offered to the user as a first predetermined selection which is known to be one that the user has ordered often in the past.

7. The method of claim 1, further comprising the steps of:
p) gathering delivery information for the user;
q) associating said delivery information with said user's identifier; and
on a call made by the user to the system after a first call made by the user to the system,
r) querying the user to determine if the user will have an order placed during said call after said first call delivered in conformance with said delivery information.

8. A telephonic menu-based ordering system personalized as a function of an identification of a user, the system comprising:
a memory for storing identification information corresponding to users of the system;
means for receiving a telephonic communication from a specific user;
means for identifying said specific user, and associating a specific identifier with said specific user;
means for comparing said specific identifier with identifiers stored in said memory;
means for establishing an initial personal history from said specific user, said initial personal history including an identifier;
means for offering said specific user an initial menu of options in a first predefined sequence;
means for receiving a first selection from said initial menu from said specific user;
means for storing said first selection from said initial menu in association with said identifier in said memory;
means for generating a first re-sequenced menu as a function of said first selection;
means for offering said specific user said first re-sequenced menu when said user has said first re-sequenced menu associated with said identifier for said specific user;
means for receiving a second selection from said first re-sequenced menu from said specific user;
means for storing said second selection from said first re-sequenced menu in association with said identifier in said memory; and
means for generating a second re-sequenced menu as a function of said second selection.

9. The system of claim 8, wherein said second re-sequenced menu is re-sequenced by weighting said second selection more highly, and therefore with greater primacy, based on at least one of the recency of said second selection compared to other selection made by said specific user and the frequency with which said specific user selects said second selection.

10. The system of claim 8, wherein said identifier is a telephone number from which said specific user calls said system.

11. The system of claim 8, wherein said function is to place the most-recently made selection at a position in said re-sequenced menu in which said most-recently made selection is offered to said specific user earlier than in a prior offered menu.

12. The system of claim 8, wherein said function is to place the menu selection most often made by the user as the first offered selection in the re-sequenced menu.

13. The system of claim 8,
wherein, after said specific user has accessed the telephone menu-based system a pre-determined number of times, and
wherein the system further comprises:
means for establishing a regular order from said specific user; and
means for offering the user a menu in which at least one item from said regular order is offered to said specific user as a first predetermined selection which is known to be one that said specific user has ordered often in the past.

14. The system of claim 8, further comprising:
means for gathering delivery information for said specific user;
means for associating said delivery information with said specific user's identifier; and
means for querying said specific user on a call made by said specific user to the system after a first call made by the user to the system, to determine if said specific user will have an order placed during said call delivered in conformance with said delivery information.

15. A method of processing orders in a telephonic menu-based ordering system, said method comprising:
providing a voice menu tree to a user, said voice menu tree having options being located on a plurality of logical branches and sub-branches from said branches; and
accepting voice input from a user in said menu tree, wherein said voice input includes a navigation command to navigate within said menu tree;
wherein said navigation command permits the user to move within the menu tree in a direction other than linearly along the current branch or sub-branch of the menu tree.

16. The method of claim 15,
wherein the menu tree includes nodes from which more than one branch or sub-branch may be followed, and
wherein said navigation command permits the user to move to a node of said menu tree other than the node which is immediately above the location on said menu tree at which the user is currently located.

17. The method of claim 15, further comprising the step of:
accepting voice input from the user to select directly an option from said menu tree, where said selected option is anywhere on said menu tree, including a location within said menu tree that is located on a branch or sub-branch of said menu tree that is different from the branch or sub-branch of the menu tree on which the user is currently located.

18. The method of claim 15, wherein said navigation command causes the user to move within the branch or sub-branch on which the user is currently located.

19. The method of claim 18, wherein the movement within the branch or sub-branch on which the user is currently located may be to a menu option other then the menu option located at the next position in the menu tree from the position at which the user is currently located.

20. The method of claim 15, wherein said navigation command permits the user to exit the voice menu tree and speak with a human operator.
